(19) United States
(12) Patent Application Publication
(10) Pub. No.: US 2025/0361412 A1
(43) Pub. Date: Nov. 27, 2025

(54) Transparent Stain Containing Metal Oxides for Antimicrobial and Antifungal Protection of Solar Photovoltaic Panels

(71) Applicants: Mikhail Inyushin, San Juan, PR (US); Legier V Rojas, San Juan, PR (US)

(72) Inventors: Mikhail Inyushin, San Juan, PR (US); Legier V Rojas, San Juan, PR (US)

(21) Appl. No.: 18/672,228

(22) Filed: May 23, 2024

(51) Int. Cl. C09D 7/61; C08K 3/22; C09D 5/14; C09D 163/00; H02S 40/10

(52) U.S. Cl. CPC C09D 7/61; C09D 5/14; C09D 163/00; H02S 40/10; C08K 2003/2237; C08K 2003/2248; C08K 2003/2296; C08K 2201/005

(57) ABSTRACT

The invention relates to a transparent stain containing transparent metal oxides, such as copper oxide, zinc oxide, or titanium oxide, with particle sizes less than 100 nm, for application on photovoltaic panels. This stain provides antifungal properties that reduce microbial growth, particularly in humid and hot equatorial regions. By maintaining the efficiency of photovoltaic panels over time, this invention addresses the problem of efficiency loss due to fungal contamination without frequent maintenance.

### BACKGROUND OF THE INVENTION

### Field of the Invention

The present invention relates to protective coatings for solar photovoltaic panels, specifically a transparent stain containing metal oxides that provide antimicrobial and antifungal properties to enhance the efficiency and longevity of photovoltaic panels.

(photovoltaic cleaning) (B08B1/12),

### Prior Art

Photovoltaic panels are widely used for solar energy generation, especially in humid and hot equatorial regions such as Central America and the southern United States. These environments are prone to high fungal (Tanner et al. 2020) and bacterial loads (Martin-Sanches, et al. 2018), which can reduce the efficiency of photovoltaic panels over time. According to Shirakawa et al. (2015), a decrease in photovoltaic power efficiency by 7% after 12 months and 11% after 18 months is associated with microbial growth. These organisms are usually protected from sunlight with special pigments, which absorb the light energy and convert it to heat, reducing the energy available for conversion to electricity and augmenting panel temperature. Existing solutions to mitigate this issue often involve regular cleaning and maintenance, which can be costly and labor-intensive. Previous inventions related to photovoltaic cleaning propose automatic mechanical cleaning. Brown Group Spain SA proposes rotating brush (ES2322745B1), Zhangye Jidian New Energy Co Ltd (China) proposes automatic mechanical cleaning of solar panels using a spray with shower nozzle, movable plate, and brush cleaner (CN215072297U), State Power Investment Group electric energy nuclear power equipment Co., Ltd (China) proposed sliding plates (CN110350861B). Another invention from China Jiliang University uses wind power for mechanical cleaning (CN106788203A). It is known that many metal oxide nanoparticles are transparent and can work as antimicrobials and antifungals, especially if irradiated by ultraviolet light which activates them, due to photocatalytic effects (Huang et al, 2023). Metal oxides are more resistant to degradation by light and temperature than organic antifungals and antimicrobials, and are less damaging to human health. Many metal oxides are used as approved pigments (with bigger particles to produce scattering) or as approved agricultural antifungals (Huang et al, 2023).

### SUMMARY OF THE INVENTION

### Brief Summary

The present invention is a transparent stain containing transparent metal oxides (such as copper or zinc oxide etc.), with particles of small sizes to maintain transparency. This stain can be applied to newly fabricated or already installed photovoltaic panels to reduce fungal and bacterial growth, thereby maintaining the efficiency of the panels over time.

### Objectives

To provide a transparent coating for photovoltaic panels that do not interfere with light absorption.

To utilize metal oxides with antimicrobial and antifungal properties to reduce microbial growth on photovoltaic panels.

To improve and maintain the efficiency of photovoltaic panels in humid and hot climates without frequent maintenance.

### DETAILED DESCRIPTION OF THE INVENTION

### Description

The invention consists of a transparent stain which includes transparent metal oxides such as copper, zinc, titanium, or any other transparent metal oxide, with particle sizes less than 100 nm. This size ensures that the metal oxides remain transparent (without significant scattering) and does not obstruct the light absorption necessary for the photovoltaic panels to function effectively.

### Components

Epoxy-based Transparent Stain: Acts as the base medium for the metal oxide nanoparticles.

Transparent Metal Oxides (Copper Oxide, Zink Oxide, or other transparent metal oxides): Provide antifungal properties and maintain transparency. Solvents and Additives: Ensure proper application and adhesion to the surface of photovoltaic panels.

### Functionality

The stain is applied to the surface of photovoltaic panels. The metal oxides within the stain (especially under UV light) exhibit oxidizing properties that degrade organic materials, including fungal spores and bacteria. This process reduces the microbial load on the panel surface, thereby maintaining its efficiency and reducing the need for frequent cleaning.

### Diagrams

Here is the detailed diagram illustrating the fabrication and application of the nanoparticle-epoxy mix to photovoltaic panels:

### See Diagram 1

All the processes presented can be separated in time.

### Embodiments

Embodiment 1: A formulation with copper oxide nanoparticles.

Embodiment 2: A formulation with titanium oxide nanoparticles (used for antibacterial and antifungal properties only).

Embodiment 3: A formulation with zinc oxide particles.

Embodiment 4: A combination of different metal oxide particles for enhanced antifungal properties.

### DRAWINGS

Detailed labeled drawing (FIG. 1) illustrating the application process and resulting reduction in microbial growth.

Description of the drawing:

FIG. 1: Photovoltaic Panel Surface Before and After Stain Application

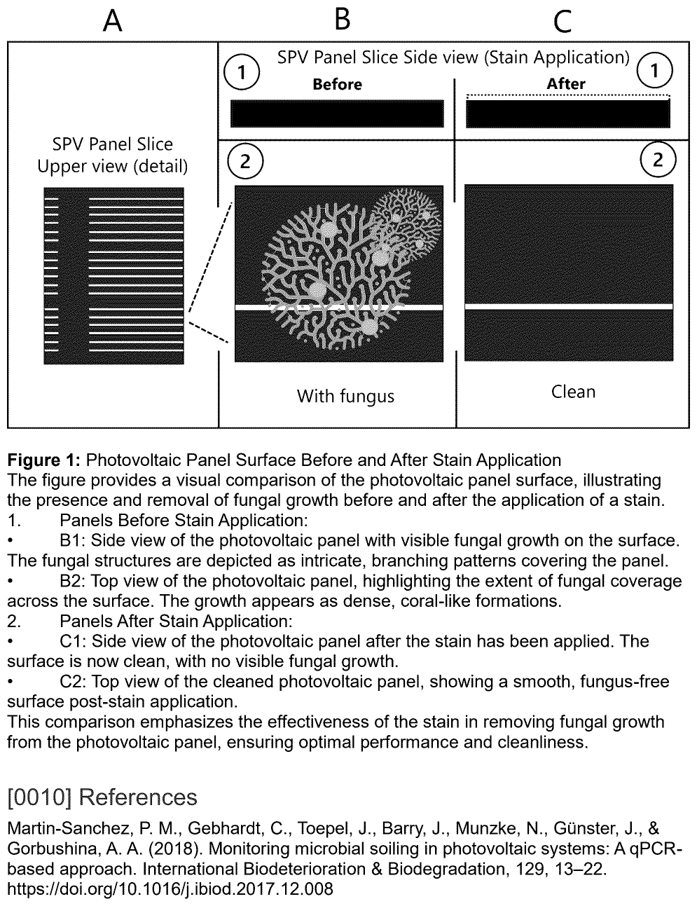

The figure provides a visual comparison of the photovoltaic panel surface, illustrating the presence and removal of fungal growth before and after the application of a stain.

1. Panels Before Stain Application:
   B1: Side view of the photovoltaic panel with visible fungal growth on the surface. The fungal structures are depicted as intricate, branching patterns covering the panel.
   B2: Top view of the photovoltaic panel, highlighting the extent of fungal coverage across the surface. The growth appears as dense, coral-like formations.
2. Panels After Stain Application:
   C1: Side view of the photovoltaic panel after the stain has been applied. The surface is now clean, with no visible fungal growth.
   C2: Top view of the cleaned photovoltaic panel, showing a smooth, fungus-free surface post-stain application.

This comparison emphasizes the effectiveness of the stain in removing fungal growth from the photovoltaic panel, ensuring optimal performance and cleanliness.

### REFERENCES

Martin-Sanchez, P. M., Gebhardt, C., Toepel, J., Barry, J., Munzke, N., Günster, J., & Gorbushina, A. A. (2018). Monitoring microbial soiling in photovoltaic systems: A qPCR-based approach. International Biodeterioration & Biodegradation, 129, 13-22. https://doi.org/10.1016/j.ibiod.2017.12.008
Tanner, K., Molina-Menor, E., Latorre-Pérez, A., Vidal-Verdú, À., Vilanova, C., Peretó, J., & Porcar, M. (2020). Extremophilic microbial communities on photovoltaic panel surfaces: A two-year study. Microbial Biotechnology, 13(6), 1819-1830. https://doi.org/10.1111/1751-7915.13620
Shirakawa, M. A., Zilles, R., Mocelin, A., Gaylarde, C. C., Gorbushina, A., Heidrich, G., Giudice, M. C., Del Negro, G. M. B., & John, V. M. (2015). Microbial colonization affects the efficiency of photovoltaic panels in a tropical environment. Journal of Environmental Management, 157, 160-167. https://doi.org/10.1016/j.jenvman.2015.03.050
Huang T, Li X, Maier M, O'Brien-Simpson NM, Heath DE, O'Connor AJ. Using inorganic nanoparticles to fight fungal infections in the antimicrobial resistant era. Acta Biomater. 2023 Mar. 1; 158:56-79. doi: 10.1016/j.actbio.2023.01.019.
CN215072297U patent application “Automatic cleaning equipment for solar panel”
Application code: Y02E10/50 Photovoltaic [PV] energy
2021-06-24-Application filed by Zhangye Jidian New Energy Co ltd,
2021-12-07-Application granted
CN106788203A patent application “Using the photovoltaic board cleaning device of wind-force”
Application code: H02S40/10 Cleaning arrangements
2016-12-07-Application filed by China Jiliang University
2018-08-07-Application granted
CN110350861B, Self-dedusting solar photovoltaic panel
Application code: B08B1/12
2019-08-09-Application filed by State Power Investment Group Electric Energy Nuclear Power Equipment Co ltd
2021-10-08-Application granted
ES2322745B1, Sistema automatico de limpieza de paneles solares
Application code: B08B1/12
2007-10-09-Application filed by Brown Group Spain SA
2010-04-08-Application granted

1. A transparent stain for photovoltaic panels, comprising epoxy-based medium and transparent metal oxides with particle sizes less than 100 nm, where the metal oxides are selected from the group consisting of copper oxide, zinc oxide, titanium oxide, and other metal oxides with antimicrobial and antifungal activity.

2. A method of protecting photovoltaic panels from microbial growth, comprising applying a transparent stain containing transparent metal oxides with particle sizes less than 100 nm to the surface of the panels.
The transparent stain of claim 1, wherein the metal oxide is copper oxide.
The transparent stain of claim 1, wherein the metal oxide is zinc oxide.
The transparent stain of claim 1, wherein the metal oxide is titanium oxide.
The method of claim 2, wherein the transparent stain further comprises additives to enhance adhesion to the photovoltaic panel surface.
The method of claim 2, wherein the transparent stain is applied to already installed photovoltaic panels.
